(19) United States
(12) Patent Application Publication
(10) Pub. No.: US 2025/0393078 A1
(43) Pub. Date: Dec. 25, 2025

(54) METHOD FOR TRANSMITTING PRACH SIGNAL, AND RELATED DEVICES

(71) Applicant: GUANGDONG OPPO MOBILE TELECOMMUNICATIONS CORP., LTD., Dongguan (CN)

(72) Inventor: Wenfeng ZHANG, Plano, TX (US)

(21) Appl. No.: 19/304,849

(22) Filed: Aug. 20, 2025

Related U.S. Application Data
(63) Continuation of application No. PCT/CN2024/077728, filed on Feb. 20, 2024.
(60) Provisional application No. 63/447,289, filed on Feb. 21, 2023.

(51) Int. Cl. H04W 74/0833; H04W 52/14; H04W 52/36

(52) U.S. Cl. CPC H04W 74/0833; H04W 52/146; H04W 52/362; H04W 52/367

(57) ABSTRACT

A method for transmitting a PRACH signal includes: transmitting a PRACH signal with a transmission power in one of multiple PRACH occasions in a random access procedure, where in response to the PRACH occasion satisfies a specific condition, the transmission power of the PRACH signal is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used.

### CROSS-REFERENCE TO RELATED APPLICATIONS

This application is a Continuation application of International Application No. PCT/CN2024/077728 filed on Feb. 20, 2024, which claims priority to U.S. Patent Provisional Application No. 63/447,289 filed on Feb. 21, 2023, which are incorporated herein by reference in their entirety.

### FIELDS OF DISCLOSURE

The presented disclosure provides new methods for transmitting or receiving Physical Random Access Channel (PRACH) in uplink subband over downlink/flexible symbols, and related devices. The present disclosure has an application to the 3GPP New-Radio (NR) system.

### RELATED ART

In the 3GPP New Radio (NR), which is a 5th Generation (5G) OFDM-based radio access technology (RAT), the radio resources are defined on a 2-dimensional time-frequency resource plain for downlink and uplink, where the downlink refers to the transmission direction from a base station (BS, or so-called gNB in 3GPP NR) to user equipments (UE) and the uplink refers to the transmission direction from UE to BS/gNB. On a resource plain, a minimum resource unit called “resource element” (RE) is defined corresponding to one subcarrier in frequency domain and one OFDM symbol in time domain. In frequency domain, twelve consecutive subcarriers construct one resource block (RB), which serves as the minimum resource allocation granularity in frequency domain. In time domain, one OFDM symbol is the minimum resource allocation granularity. Fourteen consecutive OFDM symbols construct one time slot.

As of 3GPP NR Release 17, one OFDM symbol can be configured by Radio-Resource-Control (RRC) layer signaling to be used by a user equipment (UE) as one of {downlink symbol, uplink symbol, flexible symbol}, where
Downlink symbol can be used, from UE perspective, for downlink reception only. It cannot be used by the UE for uplink transmission on any resource in the symbol.
Uplink symbol can be used, from UE perspective, for uplink transmission only. It cannot be used by the UE for downlink reception on any resource in the symbol.
Flexible symbol can be used, from UE perspective, for either downlink reception or uplink transmission, depending on the further dynamic assignment in real-time base station scheduling. However, a UE would not perform both downlink reception and uplink transmission in the same OFDM symbol in TDD spectrum, in other words, NR UE is not required to support full-duplex mode (contrary to half-duplex) in the TDD spectrum.

When it comes to NR Release-18, one duplex enhancement was proposed in 3GPP to support in TDD carrier the full-duplex operation on base station side while the half-duplex operation is maintained on user equipment side, i.e., the base station may transmit downlink signal to one UE and receive uplink signal from another UE at the same time in a TDD carrier, while no single UE performs simultaneous downlink reception and uplink transmission. Here “simultaneous” means “in the same OFDM symbol”. Further, because the motivation behind this new Release-18 feature is to improve the latency and coverage on the uplink, the 3GPP standard study focuses on partitioning some contiguous downlink resources as subband in some downlink symbols for uplink usage. Such subband is called uplink duplexing subband or simply uplink subband, which is defined as a set of consecutive resource blocks (RBs) in the frequency domain that are potentially used by base station for uplink usage. Each duplexing subband is associated with a subband bandwidth in frequency domain and a time-span in time domain. Generally there is a guard band between uplink subband and the downlink resources outside of uplink subband within the downlink or flexible symbol resource.

Physical Random Access Channel (PRACH) is used to carry random access preamble from UE to gNB. The random access preamble carries information of random access message MSG1 which is the first message flow between UE and gNB for random access purpose, and PRACH itself also provides reference signal to help gNB to adjust uplink timings of the UE. In the current 3GPP NR specification, PRACH has quite a few preamble formats:
There are four preamble formats constructed with long sequence of length 839 and designed for large cell deployment in frequency range 1 (FR1, i.e., sub-6 GHz range). These formats can be either shorter or longer than 1 ms.
There are about nine preamble formats constructed with short sequence of length 139 and designed for small cell deployments in FR1 and FR2 (i.e., millimeter-wave range). These formats are almost all shorter than 1 ms.

One random access procedure may contain multiple PRACH occasions. After an UE transmits a PRACH to gNB in one PRACH occasion, the UE waits for response from gNB. If the UE does not receive the response from gNB, the UE would transmit another PRACH for a second try in an upcoming PRACH occasion with a ramping-up transmission power to improve the probability for gNB to successfully receive the PRACH. In the current NR specification, the transmission power of PRACH in a PRACH transmission occasion i is specified as:

$${P}_{PRACH , b} ( i ) = min \{ {P}_{CMAX} ( i ) , {P}_{PRACH - target , b} + P {L}_{b} \} [ dBm ] ,$$

where
P_{CMAX}(i) is the UE configured maximum output power within transmission occasion i, which satisfies P_{CMAX,Low}≤P_{CMAX}(i)≤P_{CMAX,High}, where P_{CMAX,Low} and P_{CMAX,High} are determined by UE power class parameters and specified RF parameters.
P_{PRACH-target,b} is the PRACH target reception power that is set for active BWP b and equals to

$${P}_{0 , preamble} + {Δ}_{preamble} + ( {COUNTER}_{power\_ramping} - 1 ) \times {STEP}_{power\_ramping}$$

where
   P_{0,preamble} is the initial Random Access Preamble power.
   Δ_{preamble} is a deterministic value based on preamble format.
   COUNTER_{power_ramping} is an incremental counter that increments upon each transmitted PRACH (including the one in PRACH occasion i) since the starting of current random access procedure.
   STEP_{power_ramping} is a configured step value from {0,2,4,6} dB.
PL_{b} is the pathloss between UE and gNB for BWP b, determined based on the downlink reference signal associated with the PRACH transmission.

Having uplink transmissions in a cell-wise downlink symbol via uplink subband can generate cross-link interference (CLI), which includes
gNB-to-gNB CLI: In case a UE transmits PRACH to a gNB “A” where PRACH is in a uplink subband over a downlink symbol, the downlink signal transmitted from a neighboring gNB “B” in the resources overlapping the uplink subband may reach gNB “A” and then interfere its uplink reception of the PRACH; meanwhile, the downlink signal transmitted from the neighboring gNB “B” in the resources not overlapping but adjacent to the uplink subband may reach gNB “A”, leak into uplink subband and then interfere the uplink reception of the PRACH.
UE-to-UE CLI: In case a UE-1 transmits PRACH to a gNB “A” where PRACH is in a uplink subband over a downlink symbol, this PRACH signal may, if strong enough, reach another UE-2 served by a neighboring gNB “B” and then interfere the reception of downlink signal transmitted from gNB “B” to UE-2; meanwhile, this PRACH signal may leak over guard band and into downlink resources in the same downlink symbol and then interfere the downlink reception of signals transmitted from gNB “A” to a UE-3.

### SUMMARY

An object of the present disclosure is to propose a method of transmitting or receiving a Physical Random Access Channel (PRACH) signal and related devices.

In a first aspect of the present disclosure, a method for a user equipment (UE) to transmit a Physical Random Access Channel (PRACH) signal, includes transmitting a PRACH signal with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used.

In a second aspect of the present disclosure, a method for a base station (BS) to receive a Physical Random Access Channel (PRACH) signal, includes receiving from a user equipment (UE) a PRACH signal transmitted with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used.

In a third aspect of the present disclosure, a user equipment includes a memory; a transceiver; and a processor coupled to the memory and the transceiver, wherein the processor is configured to perform the method according to the first aspect of the present disclosure.

In a fourth aspect of the present disclosure, a base station includes a memory; a transceiver; and a processor coupled to the memory and the transceiver, where the processor is configured to perform the method according to the second aspect of the present disclosure.

In a fifth aspect of the present disclosure, a non-transitory machine-readable storage medium has stored thereon instructions that, when executed by a computer, cause the computer to perform any of the above methods.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures.

FIG. 1 is a block diagram of a user equipment (UE) and a base station (BS) (e.g., gNB) of communication in a communication network system according to an embodiment of the present disclosure.

FIG. 2 is a flowchart of a method for a UE to transmit a PRACH signal according to an embodiment of the present disclosure.

FIG. 3 is a flowchart of a method for a BS to receive a PRACH signal according to an embodiment of the present disclosure.

FIG. 4 is a schematic diagram illustrating PRACH transmissions with power ramp-up in one PRACH procedure according to an embodiment of the present disclosure.

FIG. 5 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. The terminologies in the embodiments of the present disclosure are merely for describing the purpose of the certain embodiment, but not to limit the disclosure.

In the embodiments, a method for a user equipment (UE) to transmit a Physical Random Access Channel (PRACH) signal is provided, the method includes:
transmitting a PRACH signal with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following:
a maximum value for PRACH transmission power;
a second power offset besides a first power offset for PRACH transmission in the PRACH occasion; or
a second power ramp-up step besides a first power ramp-up step for accomplishing power ramp-up, where the power ramp-up is quicker when the second power ramp-up step is used than when only the first power ramp-up step is used.

In some embodiments, the specific condition that the PRACH occasion satisfies means that at least a portion of time-frequency resource of the PRACH occasion belongs to a set of resources configured to the UE for purpose of PRACH transmission power handling.

In some embodiments, the specific condition that the PRACH occasion satisfies means that at least a portion of time-frequency resource of the PRACH occasion falls into an uplink subband and within a downlink or flexible symbol.

In some embodiments, the maximum value for PRACH transmission power is determined based on size of guard band between an uplink subband in which PRACH is transmitted and resources for downlink reception in the same symbol.

In some embodiments, the maximum value for PRACH transmission power is configured by Radio Resource Control (RRC) or System Information Block (SIB) signaling.

In some embodiments, the second power offset is configured by RRC or SIB signaling.

In some embodiments, the second power ramp-up step is configured by RRC or SIB signaling.

In some embodiments, in response to the PRACH occasion (i) satisfies the specific condition, the transmission power of the PRACH signal (P_{PRACH,b}(i)) is determined as min{P_{CMAX}(i),P_{PRACH,max}(i),P_{PRACH-target,b}+PL_{b}} dBm, where P_{PRACH-target,b}=P_{0,preamble}+Δ_{preamble}+Δ_{preamble,CLI}+(Counter₁−1)×STEP_{power_ramping}+Counter₂×STEP_{power_ramping,CLI}; otherwise the transmission power of the PRACH signal P_{PRACH,b}(i) is determined as min{P_{CMAX}(i),P_{PRACH-target,b}+PL_{b}} dBm, where P_{PRACH-target,b}=P_{0,preamble}+Δ_{preamble}+(Counter₁−1)×STEP_{power_ramping}, where P_{CMAX}(i) is UE configured maximum output power, P_{PRACH,max}(i) is the maximum value for PRACH transmission power, PL_{b} is a pathloss for BWP b, P_{0,preamble} is initial Random Access Preamble power, Δ_{preamble} is the first power offset and is a deterministic value based on preamble format, Δ_{preamble,CLI} is the second power offset, Counter₁ is a counter that increments upon every actual PRACH transmission, STEP_{power_ramping} is the first power ramp-up step and is a first step value for every actual PRACH transmission, STEP_{power_ramping,CLI} is the second power ramp-up step and is a second step value for the PRACH transmission in the PRACH occasion that satisfies the specific condition, and Counter₂ is a counter that increments upon every actual PRACH transmission in the PRACH occasion that satisfies the specific condition.

In some embodiments, both the Counter₁ and the Counter₂ are initialized to zero at the beginning of the random access procedure, and counting of the Counter₁ and the Counter₂ includes the PRACH transmission in the PRACH occasion (i).

In the embodiments, a method for a base station (BS) to receive a Physical Random Access Channel (PRACH) signal is provided, the method includes:
receiving from a user equipment (UE) a PRACH signal transmitted with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following:
a maximum value for PRACH transmission power;
a second power offset besides a first power offset for PRACH transmission in the PRACH occasion; or
a second power ramp-up step besides a first power ramp-up step for accomplishing power ramp-up, where the power ramp-up is quicker when the second power ramp-up step is used than when only the first power ramp-up step is used.

In some embodiments, the specific condition that the PRACH occasion satisfies means that at least a portion of time-frequency resource of the PRACH occasion belongs to a set of resources configured to the UE for purpose of PRACH transmission power handling.

In some embodiments, the specific condition that the PRACH occasion satisfies means that at least a portion of time-frequency resource of the PRACH occasion falls into an uplink subband and within a downlink or flexible symbol.

In some embodiments, the maximum value for PRACH transmission power is determined based on size of guard band between an uplink subband in which PRACH is transmitted and resources for downlink reception in the same symbol.

In some embodiments, the maximum value for PRACH transmission power is configured by Radio Resource Control (RRC) or System Information Block (SIB) signaling.

In some embodiments, the second power offset is configured by RRC or SIB signaling.

In some embodiments, the second power ramp-up step is configured by RRC or SIB signaling.

In some embodiments, in response to the PRACH occasion (i) satisfies the specific condition, the transmission power of the PRACH signal (P_{PRACH,b}(i)) is determined as min{P_{CMAX}(i),P_{PRACH,max}(i),P_{PRACH-target,b}+PL_{b}} dBm, where P_{PRACH-target,b}=P_{0,preamble}+Δ_{preamble}+Δ_{preamble,CLI}+(Counter₁−1)×STEP_{power_ramping}+Counter₂×STEP_{power_ramping,CLI}; otherwise the transmission power of the PRACH signal P_{PRACH,b}(i) is determined as min{P_{CMAX}(i),P_{PRACH-target,b}+PL_{b}} dBm, where P_{PRACH-target,b}=P_{0,preamble}+Δ_{preamble}+(Counter₁−1)×STEP_{power_ramping}, where P_{CMAX}(i) is UE configured maximum output power, P_{PRACH,max}(i) is the maximum value for PRACH transmission power, PL_{b} is a pathloss for BWP b, P_{0,preamble} is initial Random Access Preamble power, Δ_{preamble} is the first power offset and is a deterministic value based on preamble format, Δ_{preamble,CLI} is the second power offset, Counter₁ is a counter that increments upon every actual PRACH transmission, STEP_{power_ramping} is the first power ramp-up step and is a first step value for every actual PRACH transmission, STEP_{power_ramping,CLI} is the second power ramp-up step and is a second step value for the PRACH transmission in the PRACH occasion that satisfies the specific condition, and Counter₂ is a counter that increments upon every actual PRACH transmission in the PRACH occasion that satisfies the specific condition.

In some embodiments, both the Counter₁ and the Counter₂ are initialized to zero at the beginning of the random access procedure, and counting of the Counter₁ and the Counter₂ includes the PRACH transmission in the PRACH occasion (i).

FIG. 1 illustrates that, in some embodiments, a user equipment (UE) 10 and a base station (BS) (e.g., gNB) 20 of communication in a communication network system 30 according to an embodiment of the present disclosure are provided. The communication network system 30 includes one or more UEs 10 of a cell and the BS 20. The UE 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The processor 11 of the user equipment 10 is configured to transmit a PRACH signal with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used. This can solve issues in the prior art and address the CLI issues caused when the PRACH signal is transmitted in uplink subband over downlink/flexible symbols.

The processor 21 of the base station 20 is configured to receive from a user equipment (UE) a PRACH signal transmitted with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used. This can solve issues in the prior art and address the CLI issues caused when the PRACH signal is transmitted in uplink subband over downlink/flexible symbols.

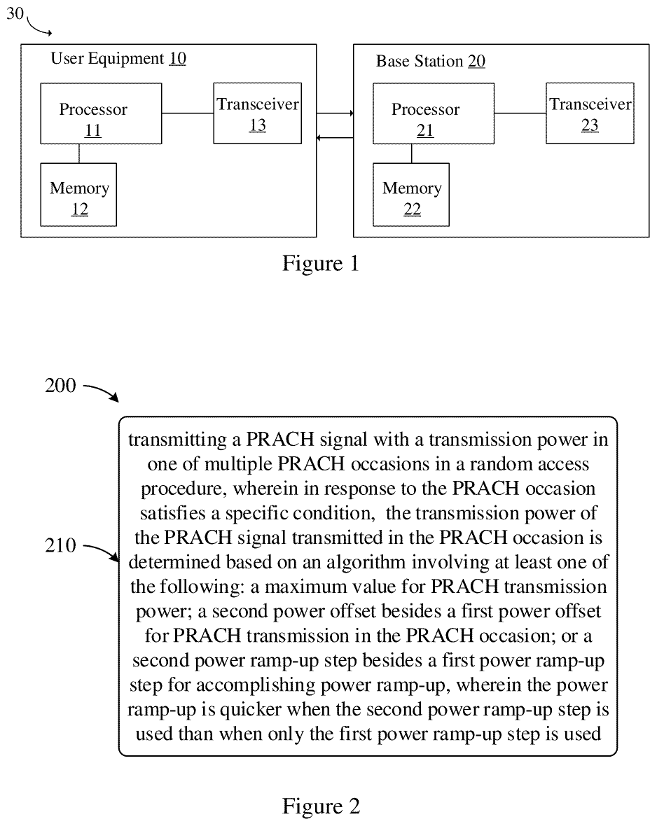

FIG. 2 illustrates a method 200 for a UE to transmit a PRACH signal according to an embodiment of the present disclosure. Referring to FIG. 2 in accompanying with FIG. 1, the method 200 includes: a block 210, transmitting a PRACH signal with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used. This can solve issues in the prior art and address the CLI issues caused when the PRACH signal is transmitted in uplink subband over downlink/flexible symbols.

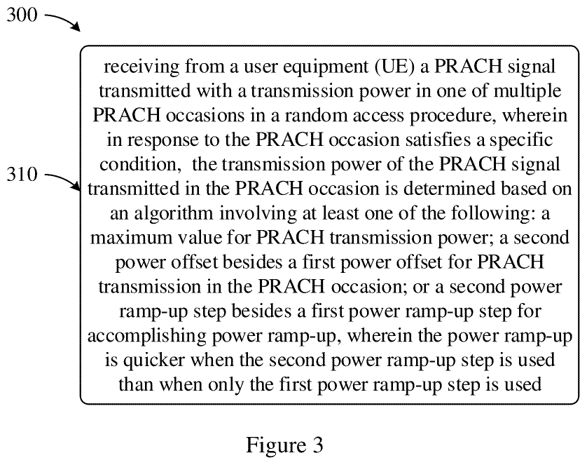

FIG. 3 illustrates a method 300 for a BS to receive a PRACH signal according to an embodiment of the present disclosure. Referring to FIG. 3 in accompanying with FIG. 1, the method 300 includes: a block 310, receiving from a user equipment (UE) a PRACH signal transmitted with a transmission power in one of multiple PRACH occasions in a random access procedure, where in response to the PRACH occasion satisfies a specific condition, the transmission power of the PRACH signal transmitted in the PRACH occasion is determined based on an algorithm involving at least one of the following: a maximum value for PRACH transmission power; a second power offset besides a first power offset for PRACH transmission in the PRACH occasion; or a second power ramp-up step besides a first power ramp-up step for accomplishing power ramp-up, where the power ramp-up is quicker when the second power ramp-up step is used than when only the first power ramp-up step is used. This can solve issues in the prior art and address the CLI issues caused when the PRACH signal is transmitted in uplink subband over downlink/flexible symbols.

The second power offset may be applied for PRACH transmission in the PRACH occasion where PRACH is victim of cross-link interference (CLI). Also, the second power ramp-up step may be applied so as to accomplish quicker power ramp-up in symbols where PRACH is victim of CLI than in symbols where PRACH is not victim of CLI.

In some embodiments, the specific condition that the PRACH occasion satisfies means that at least a portion of time-frequency resource of the PRACH occasion belongs to a set of resources configured to the UE for purpose of PRACH transmission power handling. In some embodiments, the specific condition that the PRACH occasion satisfies means that at least a portion of time-frequency resource of the PRACH occasion falls into an uplink subband and within a downlink or flexible symbol. In some embodiments, the maximum value for PRACH transmission power is determined based on size of guard band between an uplink subband in which PRACH is transmitted and resources for downlink reception in the same symbol. Alternatively, the maximum value for PRACH transmission power is configured by Radio Resource Control (RRC) or System Information Block (SIB) signaling. In some embodiments, the second power offset is configured by RRC or SIB signaling. In some embodiments, the second power ramp-up step is configured by RRC or SIB signaling.

Further details are described below.

To overcome the CLI issues, it is desirable to make PRACH transmission power to ramp-up larger within downlink/flexible symbols to combat gNB-to-gNB CLI, and to make the PRACH transmission power not to be too large to mitigate UE-to-UE CLI. The present disclosure targets to give the corresponding solutions.

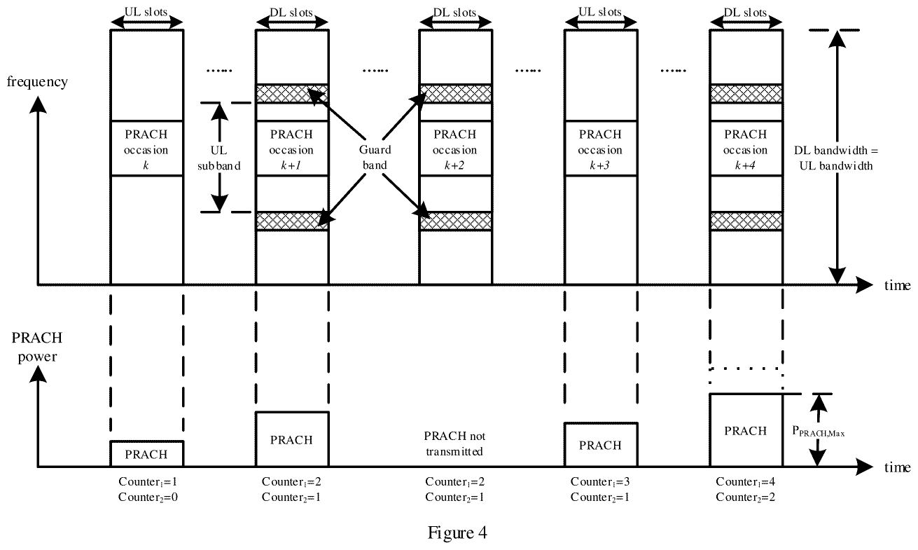

For gNB-to-gNB CLI, PRACH signal is the victim signal that is interfered at the gNB reception within downlink symbols. Therefore the remedy can be:
Besides Δ_{preamble} in related-art, an additional additive term, Δ_{preamble,CLI}, is introduced into P_{PRACH-target,b} to raise the PRACH transmission power by a constant offset for all PRACH transmissions in PRACH occasions where PRACH is victim of CLI, i.e., P_{PRACH-target,b}=P_{0,preamble}+Δ_{preamble}+Δ_{preamble,CLI}+(COUNTER_{power_ramping}−1)×STEP_{power_ramping}, where Δ_{preamble,CLI} is a power offset configured by RRC or SIB (System Information Block) signaling for PRACH transmission over downlink/flexible symbols;
Besides the power ramp-up in the related-art which applies to all actual PRACH transmissions, a second power ramp-up accumulation is introduced to be applicable only to the actual PRACH transmissions having resources in uplink subband on downlink/flexible symbols, in order to accomplish quicker power ramp-up in symbols where PRACH is victim of CLI than in symbols where PRACH is not victim of CLI. As shown in FIG. 4, besides the legacy power ramping counter, Counter₁ (i.e., COUNTER_{power_ramping} as described above), a second counter, Counter₂, is defined to initialize to zero and to count the number of actual PRACH transmissions over the symbols where PRACH is victim of CLI, i.e., the actual PRACH transmission in PRACH occasion that has resources in uplink subband and meanwhile in downlink/flexible symbols. In a PRACH occasion where PRACH is actually not transmitted due to any reason such as losing in prioritization against a downlink reception or uplink transmission of another different uplink signal/channel, this second counter (Counter₂) does not increment. That is to say, Counter₂ does not count upon the PRACH occasion where PRACH is not actually transmitted. Just like the existing counter (Counter₁) being used in related-art to accumulate the power ramp-up step STEP_{power_ramping}, the new counter (Counter₂) is used to accumulate a new power ramp-up step denoted as STEP_{power_ramping,CLI} in the present disclosure and configured to UE via RRC or SIB signaling. Both counters are set to zero before a random access process starts, and may increment upon a PRACH transmission only before being used to calculate the P_{PRACH-target,b} for the same PRACH transmission.

For UE-to-UE CLI, PRACH signal transmitted from a UE is the aggressor signal that interferes the downlink reception of another UE. Therefore it is beneficial to limit the PRACH transmission power to be no larger than a given maximum value. This maximum value for PRACH transmission power, denoted as P_{PRACH,max} in the present disclosure, can be either configured by RRC or SIB signaling or determined based on size of guard band around the uplink subband.

According to the above description, for an actual PRACH transmission in a PRACH occasion i within a PRACH procedure,
If the PRACH occasion i does not have any time-frequency resource satisfying a condition, the legacy transmission power determination for PRACH is applied as in related-art.
If the PRACH occasion i has at least a portion of time-frequency resource satisfying the same above condition, the transmission power of PRACH in the PRACH transmission occasion i is given by:

$${P}_{PRACH , b} ( i ) = min \{ {P}_{CMAX} ( i ) , {P}_{PRACH , max} ( i ) , {P}_{PRACH - target , b} + P {L}_{b} \} [ dBm ]$$

$$where$$

$${P}_{PRACH - target , b} = {P}_{0 , preamble} + {Δ}_{preamble} + {Δ}_{preamble , CLI} + ( {Counter}_{1} - 1 ) \times {STEP}_{power\_ramping} + {Counter}_{2} \times {STEP}_{power\_ramping , CLI}$$

The “time-frequency resource satisfying a condition” can refer to either of the following:
The time-frequency resource belongs to a set of time-frequency resources that are configured to UE via RRC or SIB for specific PRACH transmission power handling.
The time-frequency resource falls into an uplink subband and within a downlink or flexible symbol.

FIG. 4 below shows one example of PRACH power ramping-up across a series of five PRACH occasions in a single random access procedure, where Δ_{preamble,CLI}=1, STEP_{power_ramping}=2 and STEP_{power_ramping,CLI}=4.
In PRACH occasion k, which is assumed to be the first PRACH occasion in a random access procedure, the condition for applying Δ_{preamble,CLI} and incrementing Counter₂ is not satisfies, so the PRACH target transmission power component (P_{PRACH-target,b}) in PRACH occasion k is equal to P_{0,preamble}+Δ_{preamble}.
In PRACH occasion k+1, Counter₁=2 to count any actual PRACH transmission happening so far within the current random access procedure and Counter₂=1 to count only actual PRACH transmission happening so far within the PRACH occasions satisfying the condition (i.e., transmitted in uplink subband in downlink/flexible symbols). Therefore the PRACH target transmission power component (P_{PRACH-target,b}) in PRACH occasion k+1 is equal to P_{0,preamble}+Δ_{preamble}+7.
In PRACH occasion k+2, PRACH is not actually transmitted, so neither Counter₁ nor Counter₂ counts.
In PRACH occasion k+3, the condition for applying Δ_{preamble,CLI} and incrementing Counter₂ is not satisfies, but Counter₁ increases to 3. so the PRACH target transmission power component (P_{PRACH-target,b}) in PRACH occasion k+3 is equal to P_{0,preamble}+Δ_{preamble}+4, which is even lower than the P_{PRACH-target,b} in the earlier PRACH occasion k+2.
In PRACH occasion k+4, Counter₁=4 and Counter₂=2. The P_{PRACH-target,b} in PRACH occasion k+4 is equal to P_{0,preamble}+Δ_{preamble}+1+(4−1)×2+2*4=P_{0,preamble}+Δ_{preamble}+15. However, this P_{PRACH-target,b} makes P_{PRACH-target,b}+PL_{b} to be larger than P_{PRACH,max}, then the PRACH transmission power is limited to P_{PRACH,max}.

In summary, the present disclosure provides three new features to the PRACH transmission power determination in the PRACH occasion that satisfies a certain new condition:
A new maximum value P_{PRACH,max};
A new power offset Δ_{preamble,CLI},
A new second power ramp-up accumulation.
   The present disclosure of any one of these three new features does not depend on the other two. UE may only support one or two features, and gNB may only configure or activate one or two features.

In implementation, the above described methods and their variations may be implemented as computer software instructions or firmware instructions. Such instructions may be stored in an article with one or more machine-readable storage devices connected to one or more computers or integrated circuits or digital processors such as digital signal processors and microprocessors. In a communication system of 3GPP New-Radio, the PRACH transmission power determination in base station and user equipment and related signal processing may be implemented in form of software instructions or firmware instructions for execution by a processor in the transmitter and receiver or the transmission and reception controller. In operation, the instructions are executed by one or more processors to cause the transmitter and receiver or the transmission and reception controller to perform the described functions and operations.

Other variations and enhancements are possible based on what is mentioned here.

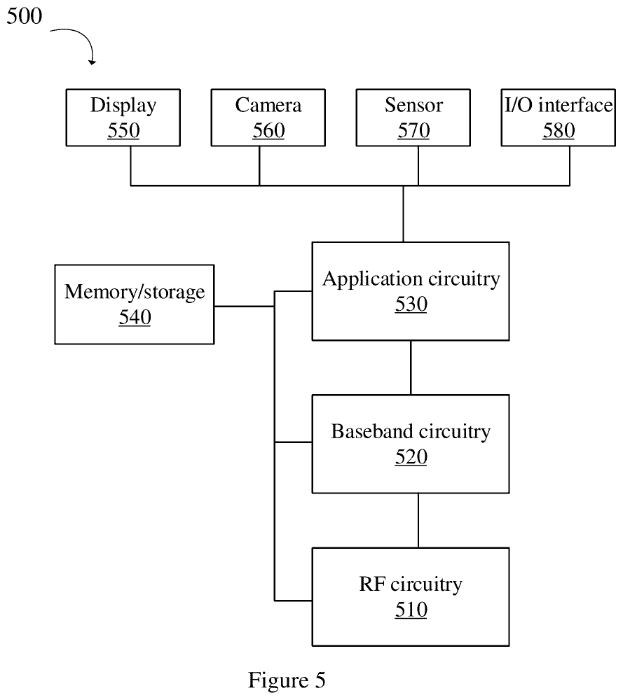

FIG. 5 is a block diagram of an example system 500 for wireless communication according to an embodiment of the present disclosure. Embodiments described herein may be implemented into the system using any suitably configured hardware and/or software. FIG. 5 illustrates the system 500 including a radio frequency (RF) circuitry 510, a baseband circuitry 520, an application circuitry 530, a memory/storage 540, a display 550, a camera 560, a sensor 570, and an input/output (I/O) interface 580, coupled with each other at least as illustrated. The application circuitry 530 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 520 may include circuitry such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 520 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 510 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 510 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 540 may be used to load and store data and/or instructions, for example, for system. The memory/storage for one embodiment may include any combination of suitable volatile memory, such as dynamic random access memory (DRAM), and/or non-volatile memory, such as flash memory.

In various embodiments, the I/O interface 580 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 570 may include one or more sensing devices to determine environmental states and/or location first information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 550 may include a display, such as a liquid crystal display and a touch screen display. In various embodiments, the system 500 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the state of application and design requirement for a technical plan. A person having ordinary skill in the art can use different ways to realize the function for each application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

It is understood that the present disclosure is not limited to the disclosed embodiments but is intended to cover various arrangements made without departing from the scope of the broadest interpretation of the appended claims.

What is claimed is:

1. A method for a user equipment (UE) to transmit a Physical Random Access Channel (PRACH) signal, the method comprising:
transmitting a PRACH signal with a transmission power in one of multiple PRACH occasions in a random access procedure, wherein in response to the PRACH occasion satisfies a specific condition, the transmission power of the PRACH signal transmitted in the PRACH occasion is determined based on an algorithm involving at least one of the following:
a maximum value for PRACH transmission power;
a second power offset besides a first power offset for PRACH transmission in the PRACH occasion; or
a second power ramp-up step besides a first power ramp-up step for accomplishing power ramp-up, wherein the power ramp-up is quicker when the second power ramp-up step is used than when only the first power ramp-up step is used.

2. The method of claim 1, wherein the specific condition that the PRACH occasion satisfies means that at least a portion of time-frequency resource of the PRACH occasion belongs to a set of resources configured to the UE for purpose of PRACH transmission power handling.

3. The method of claim 1, wherein the specific condition that the PRACH occasion satisfies means that at least a portion of time-frequency resource of the PRACH occasion falls into an uplink subband and within a downlink or flexible symbol.

4. The method of claim 1, wherein the maximum value for PRACH transmission power is determined based on size of guard band between an uplink subband in which PRACH is transmitted and resources for downlink reception in the same symbol.

5. The method of claim 1, wherein the maximum value for PRACH transmission power is configured by Radio Resource Control (RRC) or System Information Block (SIB) signaling.

6. The method of claim 1, wherein the second power offset is configured by RRC or SIB signaling.

7. The method of claim 1, wherein the second power ramp-up step is configured by RRC or SIB signaling.

8. The method of claim 1, wherein in response to the PRACH occasion (i) satisfies the specific condition, the transmission power of the PRACH signal (P_{PRACH,b}(i)) is determined as min{P_{CMAX}(i),P_{PRACH,max}(i),P_{PRACH-target,b}+PL_{b}} dBm, wherein P_{PRACH-target,b}=P_{0,preamble}+Δ_{preamble}+Δ_{preamble,CLI}+(Counter₁−1)×STEP_{power_ramping}+Counter₂×STEP_{power_ramping,CLI}; otherwise the transmission power of the PRACH signal P_{PRACH,b}(i) is determined as min{P_{CMAX}(i),P_{PRACH-target,b}+PL_{b}} dBm, wherein P_{PRACH-target,b}=P_{0,preamble}+Δ_{preamble}+(Counter₁−1)×STEP_{power_ramping}, wherein P_{CMAX}(i) is UE configured maximum output power, P_{PRACH,max}(i) is the maximum value for PRACH transmission power, PL_{b} is a pathloss for BWP b, P_{0,preamble} is initial Random Access Preamble power, Δ_{preamble} is the first power offset and is a deterministic value based on preamble format, Δ_{preamble,CLI} is the second power offset, Counter₁ is a counter that increments upon every actual PRACH transmission, STEP_{power_ramping} is the first power ramp-up step and is a first step value for every actual PRACH transmission, STEP_{power_ramping,CLI} is the second power ramp-up step and is a second step value for the PRACH transmission in the PRACH occasion that satisfies the specific condition, and Counter₂ is a counter that increments upon every actual PRACH transmission in the PRACH occasion that satisfies the specific condition.

9. The method of claim 8, wherein both the Counter₁ and the Counter₂ are initialized to zero at the beginning of the random access procedure, and counting of the Counter₁ and the Counter₂ includes the PRACH transmission in the PRACH occasion (i).

10. A user equipment, comprising:
a memory;
a transceiver; and
a processor coupled to the memory and the transceiver,
wherein the processor is configured to perform:
transmitting a PRACH signal with a transmission power in one of multiple PRACH occasions in a random access procedure, wherein in response to the PRACH occasion satisfies a specific condition, the transmission power of the PRACH signal transmitted in the PRACH occasion is determined based on an algorithm involving at least one of the following:
a maximum value for PRACH transmission power;
a second power offset besides a first power offset for PRACH transmission in the PRACH occasion; or
a second power ramp-up step besides a first power ramp-up step for accomplishing power ramp-up, wherein the power ramp-up is quicker when the second power ramp-up step is used than when only the first power ramp-up step is used.

11. The user equipment of claim 10, wherein the specific condition that the PRACH occasion satisfies means that at least a portion of time-frequency resource of the PRACH occasion belongs to a set of resources configured to the UE for purpose of PRACH transmission power handling; or
the specific condition that the PRACH occasion satisfies means that at least a portion of time-frequency resource of the PRACH occasion falls into an uplink subband and within a downlink or flexible symbol.

12. A base station, comprising:
a memory;
a transceiver; and
a processor coupled to the memory and the transceiver,
wherein the processor is configured to perform:
receiving from a user equipment (UE) a PRACH signal transmitted with a transmission power in one of multiple PRACH occasions in a random access procedure, wherein in response to the PRACH occasion satisfies a specific condition, the transmission power of the PRACH signal transmitted in the PRACH occasion is determined based on an algorithm involving at least one of the following:
a maximum value for PRACH transmission power;
a second power offset besides a first power offset for PRACH transmission in the PRACH occasion; or
a second power ramp-up step besides a first power ramp-up step for accomplishing power ramp-up, wherein the power ramp-up is quicker when the second power ramp-up step is used than when only the first power ramp-up step is used.

13. The base station of claim 12, wherein the specific condition that the PRACH occasion satisfies means that at least a portion of time-frequency resource of the PRACH occasion belongs to a set of resources configured to the UE for purpose of PRACH transmission power handling.

14. The base station of claim 12, wherein the specific condition that the PRACH occasion satisfies means that at least a portion of time-frequency resource of the PRACH occasion falls into an uplink subband and within a downlink or flexible symbol.

15. The base station of claim 12, wherein the maximum value for PRACH transmission power is determined based on size of guard band between an uplink subband in which PRACH is transmitted and resources for downlink reception in the same symbol.

16. The base station of claim 12, wherein the maximum value for PRACH transmission power is configured by Radio Resource Control (RRC) or System Information Block (SIB) signaling.

17. The base station of claim 12, wherein the second power offset is configured by RRC or SIB signaling.

18. The base station of claim 12, wherein the second power ramp-up step is configured by RRC or SIB signaling.

19. The base station of claim 12, wherein in response to the PRACH occasion (i) satisfies the specific condition, the transmission power of the PRACH signal (P_{PRACH,b}(i)) is determined as min{P_{CMAX}(i),P_{PRACH,max}(i),P_{PRACH-target,b}+PL_{b}} dBm, wherein P_{PRACH-target,b}=P_{0,preamble}+Δ_{preamble}+Δ_{preamble,CLI}+(Counter₁−1)×STEP_{power_ramping}+Counter₂×STEP_{power_ramping,CLI}; otherwise the transmission power of the PRACH signal P_{PRACH,b}(i) is determined as min{P_{CMAX}(i),P_{PRACH-target,b}+PL_{b}} dBm, wherein P_{PRACH-target,b}=P_{0,preamble}+Δ_{preamble}+(Counter₁−1)×STEP_{power_ramping}, wherein P_{CMAX}(i) is UE configured maximum output power, P_{PRACH,max}(i) is the maximum value for PRACH transmission power, PL_{b} is a pathloss for BWP b, P_{0,preamble} is initial Random Access Preamble power, Δ_{preamble} is the first power offset and is a deterministic value based on preamble format, Δ_{preamble,CLI} is the second power offset, Counter₁ is a counter that increments upon every actual PRACH transmission, STEP_{power_ramping} is the first power ramp-up step and is a first step value for every actual PRACH transmission, STEP_{power_ramping,CLI} is the second power ramp-up step and is a second step value for the PRACH transmission in the PRACH occasion that satisfies the specific condition, and Counter₂ is a counter that increments upon every actual PRACH transmission in the PRACH occasion that satisfies the specific condition.

20. The base station of claim 19, wherein both the Counter₁ and the Counter₂ are initialized to zero at the beginning of the random access procedure, and counting of the Counter₁ and the Counter₂ includes the PRACH transmission in the PRACH occasion (i).
